(19) United States
(12) Patent Application Publication
(10) Pub. No.: US 2007/0023733 A1
(43) Pub. Date: Feb. 1, 2007

(54) Electronic apparatus

(75) Inventors: Toshio Ooe, Tokyo (JP); Takahiro Omori, Kanagawa (JP); Hiroyuki Takahashi, Kanagawa (JP); Tetsuya Kugimiya, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/474,037

(22) Filed: Jun. 23, 2006

(30) Foreign Application Priority Data
Jul. 29, 2005 (JP) P2005-220867

(51) Int. Cl. C09K 19/34

(52) U.S. Cl. 252/299.61

(57) ABSTRACT

According to one embodiment, an electronic apparatus that includes: a display device having four outer edges, and four corner sections formed with the four outer edges; a housing which incorporates the display device, and has a back wall covering a back surface of the display device and an outer peripheral wall surrounding an outer periphery of the display device; and a metal fastener which has a fastening member and is fastened to the display device. The back wall includes: a first region located between the four outer edges and the outer peripheral wall; and a second region which does not include the first region and a region facing the back surface of the display device, and is located between the corner section and the outer peripheral wall. The fastening member of the metal fastener is fastened to the second region.

### CROSS-REFERENCE TO RELATED APPLICATIONS

This application is based upon and claims the benefit of priority from Japanese Patent Application No. 2005-220867, filed Jul. 29, 2005, the entire contents of which are incorporated herein by reference.

### BACKGROUND

1. Field

One embodiment of the invention relates to a display device fastening structure for retaining a display device to be incorporated in electronic apparatus.

2. Description of the Related Art

A display device of electronic apparatus is fastened to an attachment section disposed inside a cover, which serves as an external shell, by means of screws. It is disclosed by, for example, Japanese Patent Application Publication (KOKAI) No. 2000-10082 a method for attaching a liquid crystal device—serving as the display device—to a cabinet—serving as the cover. The liquid crystal device comprises a liquid crystal panel, a liquid crystal panel frame, and attachment hole conversion members.

The attachment hole conversion members, each of which comprises a main body section and bent sections, are respectively attached to the left and right sides of the liquid crystal device. The main body section is formed from a ribbon-like plate extending along the left side surface and the right side surface of the liquid crystal panel frame. The bent sections are disposed on opposite ends of the main section, and each of the bent sections is bent at the right angle in the direction departing from the liquid crystal device along the display surface of the liquid crystal device. Bosses are formed inside the cabinet. Screw holes are drilled in the bent sections at positions corresponding to positions of attachment holes formed in the bosses. The liquid crystal display device is fixed to the cabinet by fixation of the bent sections to the bosses with screws.

In the structure disclosed in JP-A-2000-10082, the bosses are disposed at positions adjacent to the right and left sides of the liquid crystal device. Notebook-type portable electronic apparatus, which is one mode of the electronic apparatus, has a liquid crystal display device serving as the display device, and is fixed to a cover in a structure disclosed in JP-A-2000-10082.

Portable electronic apparatus is sometimes unintentionally dropped while being carried. When electronic apparatus having a liquid crystal display device and the fastening structure disclosed in JP-A-2000-10082 is dropped on the side where the boss is provided, the display device collides with the boss. As a result, the display device receives an impact from the cover by way of the boss. When the impact is great, a glass substrate of the liquid display device sometimes suffers a crack originating from the vicinity of the bent section.

In addition, one of the four circumferential edges of portable electronic apparatus is positioned downward when the apparatus is carried in a bag. In this case, when the side where the boss is provided is positioned downward, merely placing the bag on a floor applies a vertical load to the apparatus by way of the boss from a side portion of the display device in an in-plane direction along the display surface thereof. Therefore, careless handling of the bag results in application, to the display device, of a physical impact which is the same as that inflicted when the bag is dropped, which may inflict damage to the display device.

The present invention provides electronic apparatus which can lessen an impact transmitted to a display device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating a portable computer having a display device fastening structure according to a first embodiment of the invention;

FIG. 2 is an exemplary exploded perspective view of a display panel of the portable computer according to the first embodiment;

FIG. 3 is an exemplary enlarged perspective view of a portion of a cover indicated by F3 in FIG. 2 according to the first embodiment;

FIG. 4 is an exemplary enlarged perspective view of a portion of the cover indicated by F4 in FIG. 2 according to the first embodiment;

FIG. 5 is an exemplary enlarged perspective view of a portion of the cover indicated by F5 in FIG. 2 according to the first embodiment;

FIG. 6 is an exemplary enlarged perspective view of a portion of the cover indicated by F6 in FIG. 2 according to the first embodiment;

FIG. 7 is an exemplary perspective view of a state in which a display device is attached to the cover illustrated in FIG. 2 according to the first embodiment;

FIG. 8 is an exemplary enlarged perspective view of a portion indicated by F8 in FIG. 7 according to the first embodiment;

FIG. 9 is an exemplary enlarged perspective view of a portion indicated by F9 in FIG. 7 according to the first embodiment;

FIG. 10 is an exemplary enlarged perspective view of a portion indicated by F10 in FIG. 7 according to the first embodiment;

FIG. 11 is an exemplary enlarged perspective view of a portion indicated by F11 in FIG. 7 according to the first embodiment;

FIG. 12 is an exemplary plan view schematically showing the cover, the display device, and metal fasteners illustrated in FIG. 7 according to the first embodiment; and

FIG. 13 is an exemplary plan view schematically showing a display device fastening structure according to a second embodiment the invention.

### DETAILED DESCRIPTION

Various embodiments according to the invention will be described hereinafter with reference to the accompanying drawings. In general, according to one embodiment of the invention, an electronic apparatus includes: a display device having four outer edges, and four corner sections formed with the four outer edges; a housing which incorporates the display device, and has a back wall covering a back surface of the display device and an outer peripheral wall surrounding an outer periphery of the display device; and a metal fastener which has a fastening member and is fastened to the display device. The back wall includes: a first region located between the four outer edges and the outer peripheral wall; and a second region which does not include the first region and a region facing the back surface of the display device, and is located between the corner section and the outer peripheral wall. The fastening member of the metal fastener is fastened to the second region.

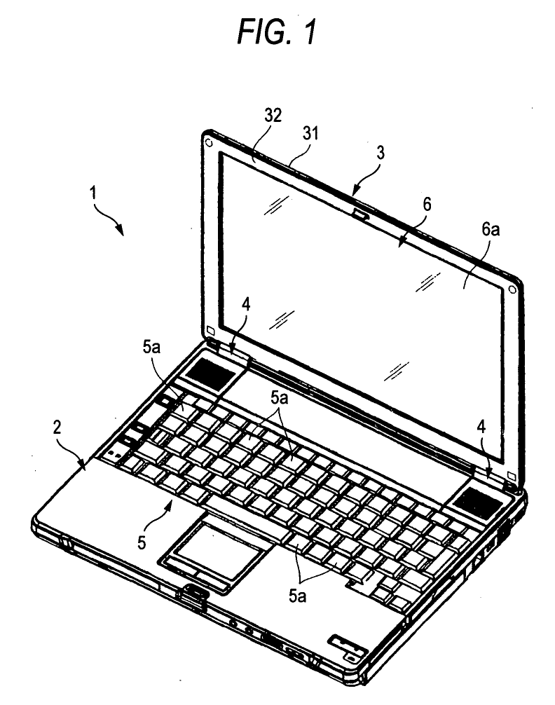

Electronic apparatus of a first embodiment according to the invention will be described by reference to FIGS. 1 to 12 while taking a portable computer 1 as an example. The portable computer 1 illustrated in FIG. 1 has a main body 2 and a display section 3. The display section 3 is coupled to the main body 2 by means of hinges 4, and pivots from a position where the display section 3 lies over the main body 2, to a position standing upright in relation to the main body 2 as illustrated in FIG. 1.

For convenience of explanation, the right, left, and front sides as viewed by a user of the portable computer 1 are defined as the right, left, and front sides respectively; and the deeper side where the hinges 4 are provided is defined as a rear side. As for the display section 3, the front and rear sides are defined with the display section 3 lies over the main body 2.

A keyboard 5 where keys 5a for use in input operations are provided is disposed on the upper surface of the main body 2. The display section 3 incorporates the display device 6 inside a housing. A display surface 6a of the display device 6 faces the keyboard 5 in a state (open state) where the display section 3 stands upright in relation to the main body 2. The display device 6 of the present embodiment is flat, and rectangular in external shape. The display device 6 is, e.g., a liquid crystal display formed by means of superimposing a glass substrate and a light guide plate for backlight. Alternatively, the display device 6 may be a plasma display, an organic electro-luminescence display, a surface-conduction electron-emitter display, or the like.

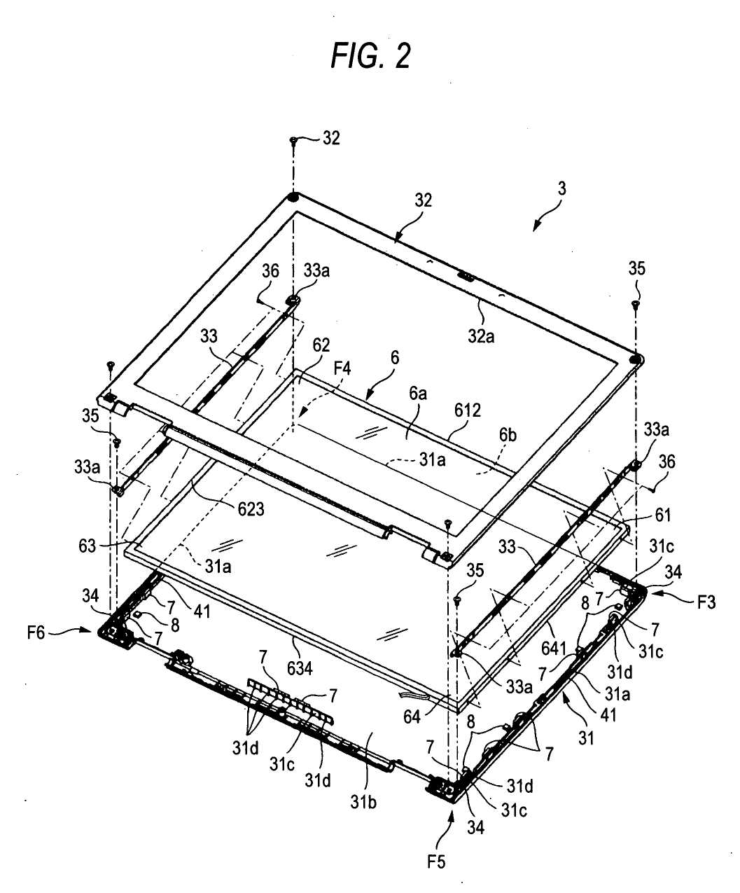

The housing of the display section 3 has a cover 31 and a mask 32 as illustrated in FIG. 1. As illustrated in FIG. 2, the display section 3 holds the display device 6 inside by means of a display device fastening structure, which comprises the cover 31, the mask 32, metal fasteners 33, and fastening screws 35. The cover 31, whose external shape is larger than that of the display device 6, covers a non-display surface (rear surface) 6b of the display device 6. The cover 31 has an outer peripheral wall 31a surrounding the outer periphery of the display device 6, and a back wall 31b opposing the non-display surface 6b.

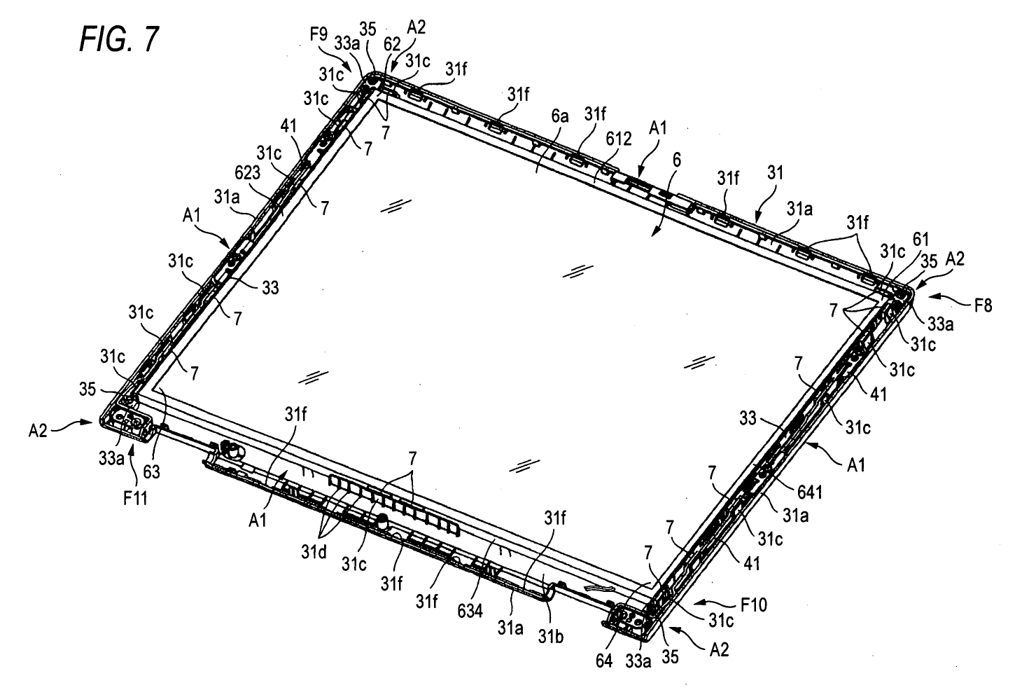

A window section 32a through which the display surface 6a is exposed is formed in the mask 32. The mask 32 is attached to the cover 31 from the side of the display surface 6a. Engagement pawls 31f are interspersed along the outer peripheral wall 31a of the cover 31, and engagement sections are provided along the outer periphery of the mask 32 so as to correspond to the engagement pawls (See FIG. 7). In the present embodiment, the outer peripheral wall 31a serves as an edge of the cover 31. An outer peripheral wall may be provided on the mask 32 in place of the outer peripheral wall 31a on the cover 31. In this case, an outermost periphery of the back wall 31b serves as the edge of the cover 31.

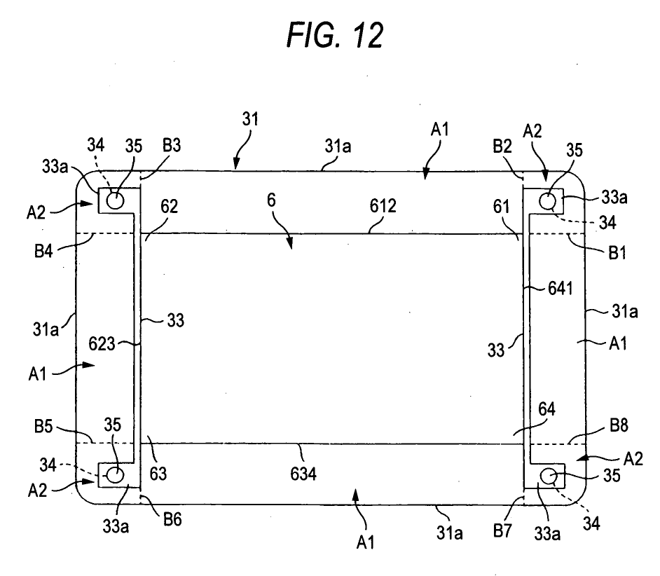

As illustrated in FIG. 12, first regions A1 and second regions A2 are defined on the back wall 31b of the cover 31. The first regions A1 are regions positioned between outer edges 612, 623, 634, and 641 of the display device 6, and the outer peripheral wall 31b of the cover 31. Each of the second regions A2 is a region surrounded by the outer peripheral wall 31a of the cover 31, and two line segments extending from respective, adjacent outer edges of the display device 6. Put another way, each of the second regions A2 is a region independent from the first regions Al and a region opposing a back surface serving as the non-display surface 6b of the display device 6, and is a region positioned between the respective corner section of the display device 6 and the outer peripheral wall 31a.

More specifically, the second region A2 on the right of the front side (hereinafter called a “front-right side”) is a region surrounded by two line segments B1 and B2 respectively extending along the outer edges 641 and 612—which are adjacent to each other at a corner section 61 of the display device 6—and the outer peripheral wall 31a of the cover 31. The second region A2 on the front-left side is a region surrounded by two line segments B3 and B4 respectively extending along the outer edges 612 and 623—which are adjacent to each other at a corner section 62 of the display device 6—and the outer peripheral wall 31a of the cover 31. The second region A2 on the rear-left side is a region surrounded by two line segments B5 and B6 respectively extending along the outer edges 623 and 634—which are adjacent to each other at a corner section 63 of the display device 6—and the outer peripheral wall 31a of the cover 31. The second region A2 on the rear-right side is a region surrounded by two line segments B7 and B8 respectively extending along the outer edges 634 and 641—which are adjacent to each other at a corner section 64 of the display device 6—and the outer peripheral wall 31a of the cover 31.

The metal fasteners 33 are respectively fastened to the outer edge 641 on the right of the display device 6 and the outer edge 623 on the left of the same as illustrated in FIG. 2, by means of machine screws 36. The machine screws are screwed-in from the first regions A1 in the in-plane direction along the display surface 6a of the display device 6. Each of the metal fasteners 33 has fastening members 33a at end sections, each of which extends to the front of the corner sections 61 or 62, or to the rear of the corner sections 63 or 64 along the display surface 6a from a portion in one of the first regions A1, at which the metal fastener 33 is adjacent to the outer edge 641 on the right of the display device 6 and to the outer edge 623 on the left of the same. Each of the fastening members 33a is disposed at a position within one of the second regions A2, apart from the corner sections 61, 62, 63, and 64 of the display device 6.

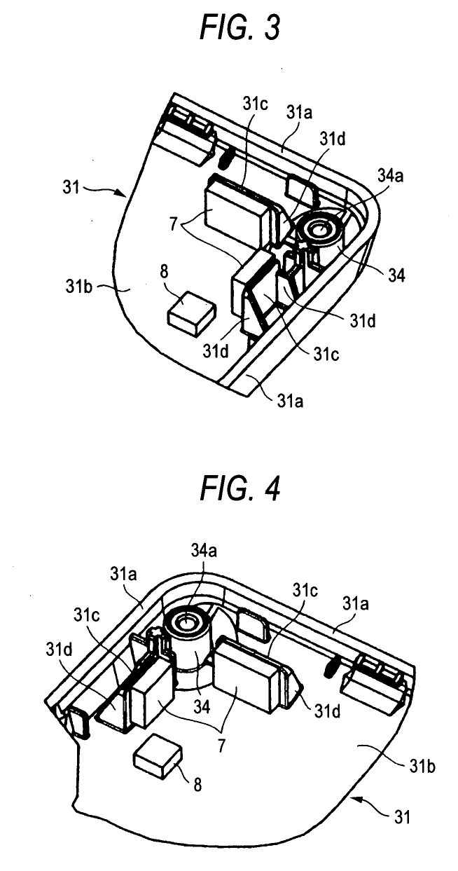

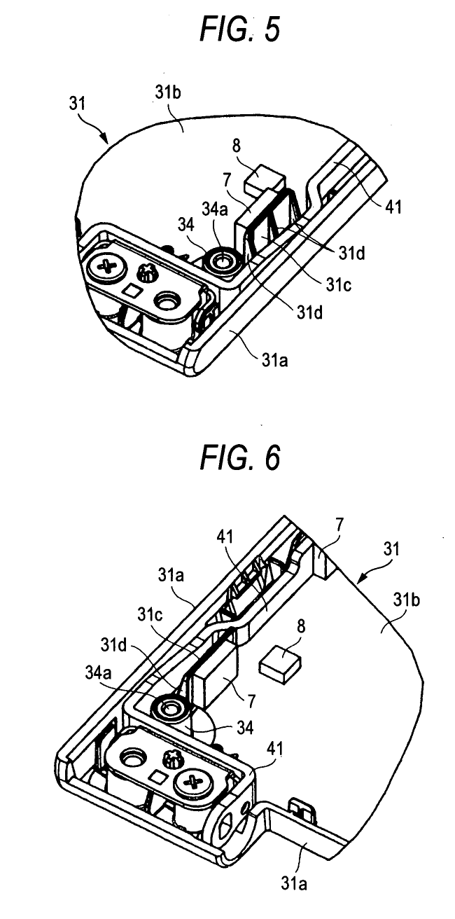

Mount seats 34, which are disposed on the cover 31 at positions corresponding to positions of the fastening members 33a, support the fastening members 33a within the second regions A2. A screw hole 34a is formed in the center of each of the mount seats 34. FIG. 3 illustrates the mount seat 34 on the front-right side, FIG. 4 illustrates the mount seat 34 on the front-left side, FIG. 5 illustrates the mount seat 34 on the rear-right side, and FIG. 6 illustrates the mount seat 34 on the rear-left side.

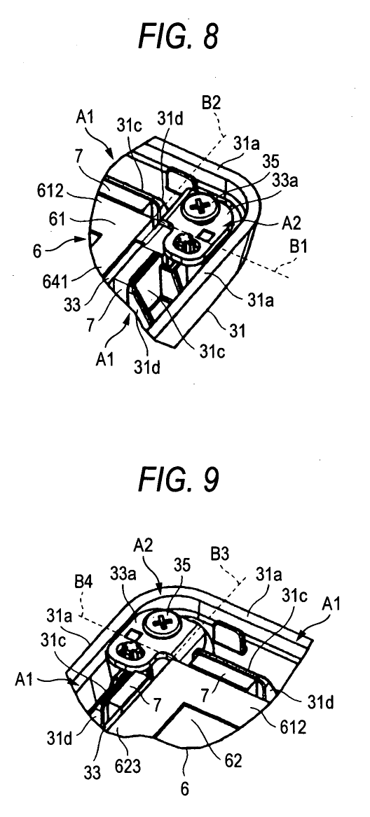

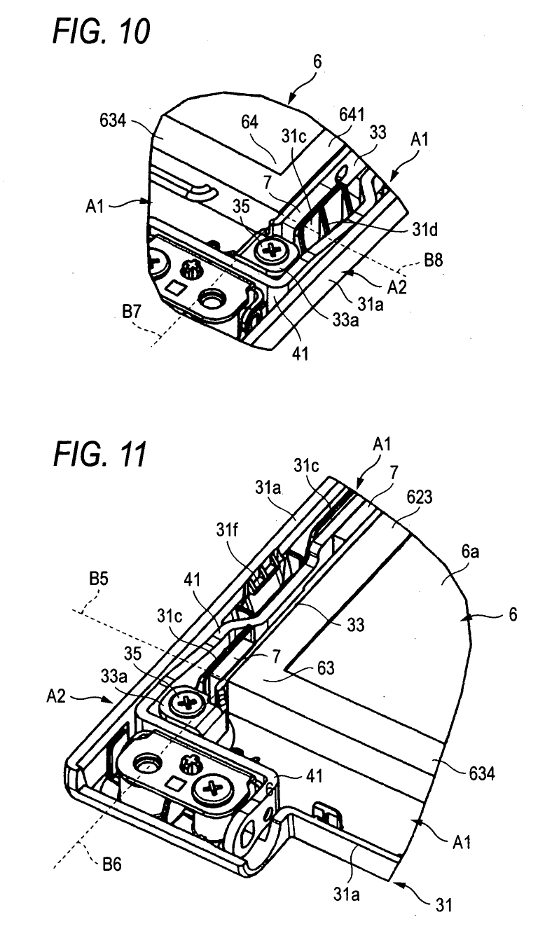

As illustrated in FIG. 7, the fastening screws 35 are screwed into the mount seats 34 formed in the second regions A2, thereby fastening the fastening members 33a to the cover 31. FIG. 8 illustrates a state in which the fastening member 33a is fastened to the mount seat 34 by the fastening screw 35 at the front-right side of the display section 3. FIG. 9 illustrates a state in which the fastening member 33a is fixed to the mount seat 34 by the fastening screw 35 at the front-left side of the display section 3. FIG. 10 illustrates a state in which the fastening member 33a is fixed to the mount seat 34 by the fastening screw 35 at the rear-right side of the display section 3. FIG. 11 illustrates a state in which the fastening member 33a is fixed to the mount seat 34 by the fastening screw 35 at the rear-left side of the display section 3.

FIGS. 7 to 11 illustrate the state in which the mask 32 is not attached. However, in the present embodiment, the fastening screws 35 to be screwed into the second regions A2 on the front-right and front-left sides also serve as screws for fixing the mask 32 as illustrated in FIG. 2. By virtue of this configuration, the number of screws can be reduced. The fastening screws 35 to be screwed in the second regions A2 on the rear-right and rear-left sides can also serve as screws for fixing the mask 32. Employment of this configuration can further reduce the number of screws.

In the present embodiment, the mount seats 34 are disposed on the cover 31. Therefore, the fastening screws 35 are screwed-in from the mask 32. Alternatively, the mount seats may be provided on the side of the mask so that the fastening screws are screwed-in from the non-display surface. In this case, a configuration of attaching the cover 31 to the mask 32 by means of an interference fit may be employed, in consideration of external appearance.

As illustrated in FIGS. 2, 5, and 6, an arm 41 of the right hinge 4 for coupling the display section 3 to the main body 2 is inserted to the first region A1—which is between the outer edge 641 on the right of the display device 6 and the outer peripheral wall 31a of the cover 31—while wrapping around the first region A1—which is between the outer edge 634 on the rear of the display device 6 and the outer peripheral wall 31a of the cover 31—and subsequently around the second region A2 on the rear-right side. In addition, another arm 41 of the left hinge 4 is inserted to the first region A1—which is between the outer edge 623 on the left of the display device 6 and the outer peripheral wall 31a of the cover 31—while wrapping around the first region A1—which is between the outer edge 634 on the rear of the display device 6 and the outer peripheral wall 31a of the cover 31—and subsequently around the second region A2 on the rear-left side. Each of the drawings illustrates the state in which only the arms 41 are attached to the cover 31. However, in practice, the arms 41 are assembled to the cover 31 in a state of having been assembled as the hinges 4.

As shown in FIGS. 3 to 6, the cover 31 has ribs 31c in the first regions A1. The ribs 31c, which are apart from the outer edges 612, 623, 634, and 641 and the outer peripheral wall 31a of the cover 31, stand upright in the thickness direction of the display device 6 from the back wall 31b of the cover 31. Each of the ribs 31c has a reinforcement rib 31d whose longer leg is on the side opposite the side facing the display device 6.

Elastic members 7 are attached the rib 31c and the arms 41, and are oriented parallel with the outer edges 641 and 623 of the display device 6 so as to face the display device 6. Each of the elastic members 7 is a shock absorbing member whose damping factor is sufficiently large to absorb a component in the in-plane direction along the display surface 6a of an impact load applied to the display section 3. In addition, elastic members 8 are attached to the back wall 31b at positions in the vicinity of the ribs 31c so as to face the non-display surface 6b of the display device 6. Each of the elastic members 8 is a shock absorbing member whose damping factor is sufficiently large to absorb a component in a direction perpendicular to the display surface 6a of the impact load applied to the display section 3.

Each of the elastic members 7 and 8 is attached in a state of having a gap with respect to the corresponding outer edge 612, 623, 634, or 641 of the display device 6, or in a state of being in contact with the same. The elastic members 7 and 8 are not limited to the shock absorbing members, and may be cushioning members configured so as to be slightly compressed when the display device 6 is assembled in the cover 31. An essential requirement for each of the elastic members 7 and 8 is to have a cross-sectional area required for respectively absorbing the shock exerted to the display device 6. Therefore, the elastic members 7 and 8 are disposed at a plurality of independent positions in a discontinuous manner.

According to the display device fixation structure configured as above, the display device 6 is fixed by means of only the fastening members 33a of the metal fasteners 33 extending from the first regions A1 to the second regions A2. In addition, the fastening members 33a are apart from the corner sections 61, 62, 63, and 64 of the display device 6. Therefore, even when a perpendicular impact load is applied to any of the outer edges 612, 623, 634, and 641 of the display device 6 when the portable computer 1 is dropped, or the like, the corresponding metal fastener 33 deforms at a position between the corner section 61, 62, 63, or 64 and the corresponding fastening member, thereby damping and lessening the impact load. As a result, the display device 6 is protected from breakage caused by the impact exerted due to dropping, or the like. In addition, since the display device 6 is fixed only to the second regions A2, in a case where the metal fastener 33 is deformed to thus deviate the display device 6 from a normal position, the display device 6 is prevented from colliding with a rigid portion.

Furthermore, the elastic members 7 are attached to the ribs 31c disposed in the first regions A1, and the elastic members 8 are attached to the back wall 31b facing the non-display surface 6b. Hence, in the case where the metal fixture 33 is deformed, the display device 6 can be effectively received. In addition, each of the fastening members 33a is fastened to the mount seat 34 by means of a single fastening screw 35. Therefore, each of the end sections of the metal fasteners 33 extending from the first region A1 easily pivots about the fastening screw 35 by a load in the in-plane direction along the display surface 6a, thereby effectively absorbing an impact load applied to the display device 6.

Furthermore, according to the display device fastening structure, in a case when an impact load is applied from any one of the corner sections of the display section 3, the corresponding metal fastener 33 is deformed, thereby damping and lessening the impact load, and, in conjunction therewith, the weight of the display device is applied to the elastic members 7 disposed at two of the first regions A1 which are adjacent to the corner section 61, 62, 63, or 64 of the display device 6 corresponding to the portion where the impact load is applied. As a result, application of a localized load on the display device 6 can be prevented, thereby preventing breakage of the display device 6.

Furthermore, each of the metal fasteners 33 integrally includes the fastening members 33a which are respectively disposed on two adjacent second regions A2. Accordingly, when an impact load is applied to the display section 3 from the outside, the impact load input by way of the mount seats 34 and the fastening members 33a can be prevented from concentrating on the machine screw 36 which attaches the metal fixture 33 to the display device 6. Put another way, in a case where the portable computer 1 is dropped on a corner of the display section 3, or the like, an impact load applied to the fastening member 33a in the second region A2 at the corner can be absorbed by the fastening member 33a on the opposite side.

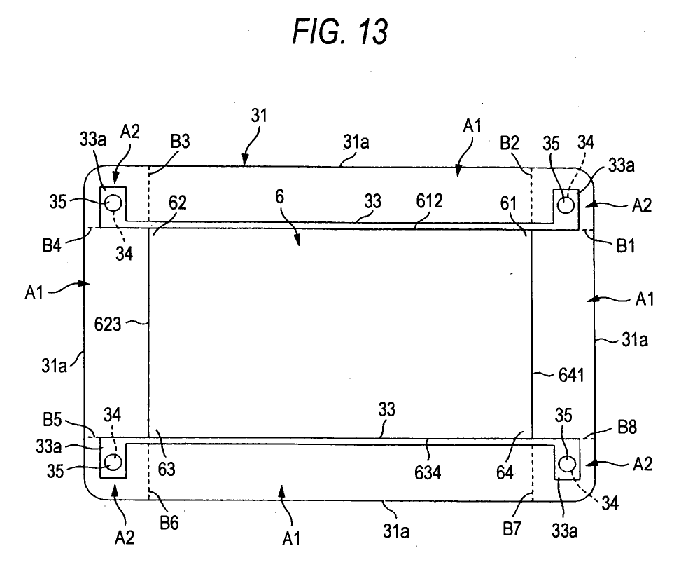

A display device fastening structure of a second embodiment according to the invention will be described by reference to FIG. 13. The display device fastening structure of the present embodiment differs from the display device fastening structure described in the first embodiment in positions where the metal fasteners 33 are attached in relation to the display device 6. In the first embodiment, the metal fasteners 33 are attached to the outer edge 641 on the right of the display section 3 which pivots by means of the hinges 4, and to the outer edge 623 on the left of the same.

In contrast, in the present embodiment, as illustrated in FIG. 13, the metal fasteners 33 are attached to the outer edge 612 on the front of the display section 3, and to the outer edge 634 on the rear of the same. The display device fastening structure of the present embodiment is identical in configuration with that having been described in the first embodiment, and repeated descriptions are omitted.

The above embodiments have been described while taking the portable computer 1 as an example of the electronic apparatus. However, the same effects as those yielded above can also be yielded in a case where the display device fastening structure according to the invention is applied to any electronic apparatus having the display device 6, such as electronic apparatus having a display device; e.g., a cellular phone, a personal digital assistant (PDA), a digital camera, or a digital video camera. Alternatively, the display device fastening structure according to the embodiment can also be applied to, in place of the display device, a retaining structure to a storage device which has a fine driving section.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display device having four outer edges, and four corner sections formed with the four outer edges;
a housing which incorporates the display device, and has a back wall covering a back surface of the display device and an outer peripheral wall surrounding an outer periphery of the display device; and
a metal fastener which has a fastening member and is fastened to the display device, wherein
the back wall includes:
a first region located between the four outer edges and the outer peripheral wall; and
a second region which does not include the first region and a region facing the back surface of the display device, and is located between the corner section and the outer peripheral wall, and
the fastening member of the metal fastener is fastened to the second region.

2. The electronic apparatus according to claim 1, wherein
the metal fastener integrally includes two of the fastening members; and
the two fastening members are respectively positioned at two of the second regions which are adjacent to each other.

3. The electronic apparatus according to claim 1, wherein
the housing has a mount seat, to which the fastening member is fastened, and
the mount seat is disposed only in the second region.

4. The electronic apparatus according to claim 2, wherein the metal fastener is fastened to an opposing outer edge of the display device.

5. The electronic apparatus according to claim 1, further comprising:
a rib disposed in the first region of the back wall at a position apart from the outer peripheral wall opposing to the outer edge of the display device; and
an elastic member disposed at between the outer edge of the display device and the ribs, or at between the back surface of the display device and the back wall of the housing.
